(19) United States
(12) Patent Application Publication
(10) Pub. No.: US 2010/0095592 A1
(43) Pub. Date: Apr. 22, 2010

(54) GASIFIER

(75) Inventor: Marcel Bernard Huber, Flaurling (AT)

Correspondence Address: FOLEY AND LARDNER LLP;SUITE 500, 3000 K STREET NW, WASHINGTON, DC, 20007, US

(73) Assignee: SynCraft Engineering GmbH

(21) Appl. No.: 12/531,270

(22) PCT Filed: Mar. 14, 2008
(86) PCT No.: PCT/EP2008/002085

§ 371 Date: Nov. 20, 2009

(30) Foreign Application Priority Data
Mar. 15, 2007 (DE) 102007012452.1

(51) Int. Cl. C10J 3/48; C01B 3/36

(52) U.S. Cl. 48/62 R; 48/197 R

(57) ABSTRACT

Described is a device for oxidizing a material comprising a material inlet port, a material outlet port and an oxidation zone extending therebeteween, the device comprising at least one nozzle unit (7, 8) for introducing a gasification agent arranged and/or configured such that the material is transported by the gasification means from the material inlet port through the oxidation unit (2) to the material outlet port. A multi-stage gasifier according to the invention, in particular a full stream gasifier, preferably comprises individual components in a simple, low-maintenance and slag-proof design, and can preferably optionally be upscaled. The produced synthesis gas can preferably be used for subsequent gas utilization without that a complex gas purification is required.

The present invention relates to a device and a corresponding process for thermochemically converting biomass or carbonaceous raw materials, in particular wood chips, into combustion gas, in particular lean gas or synthesis gas.

After a drying step, in particular for eliminating any water content in the biomass, the biomass is pyrolized into gaseous and volatile components. Pyrolysis is carried out in particular under thermal influence of preferably from about 200° C. to 700° C. To prevent combustion of the biomass, pyrolysis is performed in a corresponding atmosphere. Pyrolysis is preferably conducted substantially under exclusion of air or oxygen. End products of the thermochemical decomposition are in particular gases such as CO, CO₂, H₂, CH₄, volatile, oily components, coke and/or steam.

Subsequently, an oxidation or partial oxidation takes place. In this connection, the portion of the full stream, preferably the unseparated mass or material stream of the pyrolysis product, which is solid and liquid until this process step is also at least partially converted into a gaseous form by introducing gasification agents, such as air, steam, carbon dioxide and/or oxygen. The partial oxidation process preferably takes place in temperature ranges from about 800° to 2000°, preferably from about 1000° to 1300° C., with such temperatures allowing decomposition or cracking of part of the substances, such as tars, formed during pyrolysis.

This is followed by reduction. In reduction, in particular the substances resulting from oxidation react. Preferably, the initially high temperatures resulting from oxidation are reduced, in particular due to endothermy of the redox reactions.

Thereafter, after corresponding cooling and any energy recovery and purification steps, the produced gas may be used for the operation of thermal engines or the like. Alternatively or additionally, the produced gas may be subjected to a further finishing process, for example, for bio fuel production, or used, for example, in fuel cells.

On the basis of the first developments in this area, a large number of further developments was made which substantially were aimed at utilizing biomass. In the following, known processes are briefly discussed.

The fluidized bed gasification, as described, for example, in DE-A-4 413 923 is inter alia characterized in that large amounts of raw material can be efficiently converted. The rapid pyrolysis on which the process is based leads to high concentrations of tars in the product gas. Therefore a complex gas purification becomes necessary, so that it will be rather difficult to economically operate even large plants.

The process of fixed-bed gasification, performed by single-stage co-current gasifiers or counter-current gasifiers, as described, for example, in applications EP-A-1 203 802, DE-U-20 2004 011 213, DE-A-100 307 78 or WO9426849, is mainly characterized by its straightforward design. However, with regard to controllability, plant size, purity of the gas and also flexibility regarding raw materials, fixed-bed gasification is considerably qualified. In addition, even in low ash content fuels, there exists a high risk of slagging in the area of the fixed bed support, which is formed, e.g. by a grate.

Single-stage counter-current gasification, as described, for example, in patent applications WO-A-2005047436 and DE-A-33 46 105, additionally involves a condensate residue content in the product gas similarly high as the one in fluidized bed gasification. Moreover, it is rather difficult to introduce air into the oxidation zone, in particular in larger plants.

Multi-stage gasification concepts make use of the option of spatially separating the individual process stages of thermochemical conversion, i.e. drying, pyrolysis, oxidation and reduction. In this connection, the design of the pyrolysis unit is of secondary importance and is performed according to established processes, as described, for example, in DE-A-31 26 049.

As described in patent applications WO-A-0250214 and JP-A-2003253274, after pyrolysis the solid stream can be processed separately from the gas stream. This allows obtaining very pure synthesis gas from the solid fraction. The pyrolysis gas fraction, in particular comprising gaseous components as well as the tar or condensate fraction resulting from pyrolysis, which represents up to 80% of the input mass stream, can, however, be efficiently utilized in part only. Furthermore, an additional utilization unit for the second mass flow is required. Processes which again merge the mass flows after their separation, as described e.g. in patent applications WO-A-9921940, WO-A-0168789 and WO-A-0006671, are also known. However, complex manipulation units are required for this process step. In both cases, the core elements of the process become more complicated and substantially more expensive.

There is further known a process in which the full stream from the pyrolysis process, including solid, liquid and gaseous portions, is partially oxidated before it passes through a fixed bed consisting of pyrolysis coke or the like, resulting in a reduction of the bed material. Patent applications DE-A-198 46 805, WO-A-0114502 and WO-A-0183645 describe, e.g., such a procedure. In view of the spatially separated partial oxidation, this process allows high gas qualities, and simultaneously high flexibility regarding raw material, high efficiency and comparatively low plant costs. One substantial problem with this process is the limited performance thereof caused by a pressure loss occurring in the fixed bed, as discussed in the publication “Pressure characterization of multi-staged fixed-bed gasification plants” of Huber, M., Kreutner, G., Berlin 2007, so that it does not appear to be possible to realize gasification plants with a gas output of more than 1 MW. Just as in the case of single-stage fixed-bed gasification systems, slagging in the area of the fixed bed also impedes a reliable long-term operation of this process.

It is the object of the present invention to provide an improved device and a corresponding process for gasification of biomass or carbonaceous raw materials. This object is achieved with the features of the patent claims. The dependent claims relate to preferred embodiments of the invention.

Alternatively or additionally, the object is achieved by the following aspects of the invention:

1. Device for at least partially oxidizing a full stream including solid, liquid and gaseous material, comprising a material inlet, a material outlet, and an oxidation area extending therebetween, the device comprising at least one unit for introducing gaseous agents, in particular gasification or oxidation agents and/or transportation agents, arranged and/or configured such that the full stream is pneumatically transported from the material inlet through the oxidation area to the material outlet. Preferably, the device has exactly one material inlet and/or exactly one material outlet. It is further preferred that the at least partially oxidized full stream is led through the exactly one material outlet.

2. Device according to aspect 1, wherein the full stream is continuously transported.

3. Device according to aspect 1 or 2, wherein the transport of the full stream is simultaneous with the at least partial oxidation of the material.

4. Device according to any one of claim 1, 2, or 3, wherein the transport of the full stream and/or the at least partial oxidation is caused by the gasification or oxidation agent.

5. Device according to any one of the previous aspects, wherein at least one first nozzle unit for introducing the gasification or oxidation agent into the oxidation area is arranged close to the material inlet and/or close to the material outlet, in particular for achieving the blending of the gasification or oxidation agent and the full stream and/or for effecting the transportation of the full stream.

6. Device according to any one of the previous aspects, wherein the oxidation area close to the material inlet is designed as Venturi nozzle, so that the full stream is transported according to the Venturi principle.

7. Device according to any one of the previous aspects, with flow-affecting fixtures in the oxidation area, which fixtures are designed to promote blending of the gasification or oxidation agent and the full stream.

8. Device according to any one of the previous aspects, wherein the full stream is transported substantially independently of oxidation and preferably substantially alone by a suitable adjustment of volume flow and flow cross-section and the introduction of an additional substance flow, preferably of the gasification agent.

9. Device according to any one of the previous aspects, wherein the gasification agent is introduced at at least two different positions, preferably along the route of transport and/or along the circumference of the oxidation unit and/or along the circumference in the lower part of a reduction unit located downstream of the oxidation unit, and preferably by means of injection.

10. Device according to any one of the previous aspects, wherein the nozzles, preferably swirl nozzles, in particular for introducing or injecting a gasification agent, are mounted at the end of the oxidation unit and/or in the lower part of a reduction unit located downstream of the oxidation unit, for influencing the flow of solid, gaseous or liquid components.

11. Device according to any one of the previous aspects, wherein the ignition temperature and/or ignition energy required for initializing oxidation is externally supplied by means of a heating device, in particular an igniting or combustion device, at any position along the oxidation zone.

12. Device according to any one of the previous aspects, wherein decomposed material, preferably as full stream comprising gaseous, solid and liquid components, is thermally introduced into the oxidation unit, preferably by pyrolysis, at the material inlet.

13. Device according to any one of the previous aspects, wherein the material outlet of the oxidation unit is connected to a reduction unit so that the at least partially oxidized full stream, is supplied, in particular directly or unseparatedly, to the reduction unit in order to generate product gas and synthesis or lean gas, respectively.

14. Device according to aspect 13, wherein the product gas or the synthesis or lean gas is at least partially returned from the reduction unit or from downstream parts of the plant into a device component located upstream of the oxidation unit.

15. Device according to any one of the previous aspects, wherein the flow cross-section of the device, in particular of the oxidation area, which extending from the material inlet to the material outlet is constant and/or at least partially increases and/or decreases, is designed, in particular, as Venturi tube.

16. Device according to any one of the previous aspects, comprising a preferably approximately tubular material-supplying section which is arranged upstream of the material inlet of the oxidation unit and has a flow cross-section larger than the flow cross-section of the oxidation unit, in particular in the area of the material inlet of the oxidation unit.

17. Device according to any one of the previous aspects, with the device comprising a pyrolysis device upstream of the oxidation unit, and wherein the device is designed such that the full stream supplied to the material inlet of the oxidation unit comes from the pyrolysis device.

18. Device according to any one of the previous aspects, with at least one stabilization unit provided to stabilize the material flow, at least in curves or bends, in the direction of extent of the oxidation unit.

19. Device according to any one of the previous aspects, wherein the velocity of the material flow is adjustable or controllable by the introduction of the gasification agent of the material.

20. Device according to any one of the previous aspects, wherein a reduction unit located downstream of the oxidation unit comprises at least one material retention means for solid and/or liquid components of the material.

21. Device according to any one of the previous aspects, with a material returning unit for returning into the oxidation unit solid and/or liquid components of the material from a reduction unit located downstream of the oxidation unit.

22. Device according to aspect 21, wherein the oxidation unit comprises a second material inlet for introducing material components returned from the reduction unit.

23. Device according to any one of the previous aspects, wherein energy is recycled to a pyrolysis unit for thermally decomposing material.

24. Device according to any one of the previous aspects, wherein the material comprises biomass, in particular carbonaceous raw materials.

25. Device according to any one of aspects 1 to 24, wherein a reduction unit located downstream of the oxidation area has a cross-section tapering towards a material outlet port of the oxidation device, which cross-section is preferably approximately trumpet-shaped.

26. Device according to any one of the previous aspects, wherein a reduction unit located downstream of the oxidation area is arranged substantially upright or vertically, so that the material flow through the reduction unit substantially occurs vertically and preferably contrary to gravitation.

27. Device according to any one of the previous aspects, wherein a reduction unit located downstream of the oxidation area is approximately trumpet-shaped so that a stable bed held in suspension, preferably without the use of additional bed material, is present in the reduction unit and/or the flow rate of the material stream is substantially constant over the cross-section of the reduction unit.

28. Device according to any one of the previous aspects, wherein a reduction unit located downstream of the oxidation area has an overflow for discharging solid, liquid or gaseous substances.

29. Device according to aspect 28, wherein the overflow is arranged around the reduction unit, and has at least one downward leading discharge pipe, with the material being discharged gravimetrically.

30. Device according to aspect 28 and 29, wherein the overflow comprises a mechanical discharge system.

31. Device for oxidizing a material, in particular according to any one of aspects 1 to 30, comprising a material inlet, a material outlet, an oxidation area extending therebetween, and a reduction unit, the device comprising at least one unit for introducing the gasification agent, which unit is so arranged and/or designed, that the material is pneumatically transported by the introduced gasification agent from the material inlet through the oxidation unit to the material outlet and through the latter, and the material outlet is connected to the reduction unit such that material discharged from the material outlet ends up in the reduction unit.

32. System for thermochemically converting fuel material, in particular biomass or carbonaceous raw materials, such as wood chips, into combustion gas, comprising in particular a device according to any one of aspects 1 to 31, with
(i) a pyrolysis unit for thermally decomposing the fuel material, in particular to a full stream comprising solid, liquid and gaseous material;
(ii) an oxidation unit located downstream of the pyrolysis unit for oxidizing the full stream, in particular according to any one of aspects 1 to 31, and
(iii) a reduction unit located downstream of the oxidation unit,
said system being so designed that the full stream from the oxidation unit is supplied to the reduction unit for generating combustion gas.

33. Reduction unit for reducing a material stream discharged from an oxidation unit, in particular a full stream discharged from an oxidation unit according to any one of aspects 1 to 30, with the inner walls of the reduction unit being substantially trumpet-shaped so that a bed is formed that is substantially held in suspension.

34. Process for oxidizing a material by means of an oxidation device, in particular according to any one of aspects 1 to 31 or a system according to aspect 32, comprising the following steps: introducing a full stream, including solid, liquid and gaseous materials, into the material inlet of the oxidation device, introducing a gaseous transportation and/or a gasification or oxidation agent for at least partially oxidizing the material, such that the full stream is pneumatically transported from a material inlet through the oxidation unit to a material outlet of the oxidation unit.

35. Process according to aspect 34, comprising the step of thermally decomposing the material in a pyrolysis unit prior to introducing the gasification agent.

36. Process according to any one of aspects 34 or 35, wherein the material is oxidized in the oxidation device substantially without external energy supply.

37. Process according to any one of aspects 34 to 36, with the step of adjusting or controlling the flow rate of the material stream in the oxidation unit by controlled introduction of the transportation or gasification agent.

38. Process according to any one of aspects 34 to 37, with the step of reducing the oxidized material in a reduction unit for at least partially gassifying solid and/or liquid components.

39. Process according to any one of aspects 34 to 38, wherein the unseparated full stream is transported, preferably pneumatically, in and through the oxidation unit, preferably through the oxidation unit, into the reduction unit.

A multi-stage gasifier according to the invention, in particular a full stream gasifier, preferably comprises individual components having a simple, low-maintenance and slag-proof design. Moreover, it is preferably not restricted to plant sizes of a gas output below 1 MW, and in particular not limited with regard to size or performance but can optionally be upscaled. The produced combustion gas, hereinafter also referred to as product gas, lean gas or synthesis gas, can preferably be used for subsequent gas utilization without requiring complex gas purification. Lean gases are in particular gas mixtures having a reduced heating value, e.g. below 8.5 MJ/Nm². By the multi-stage process, preferably also raw materials of different sizes can be efficiently processed to synthesis gas.

The invention is based on the idea to at least partially oxidize in an oxidation unit a full stream resulting from pyrolysis, i.e. in particular the unseparated material flow having solid, liquid and gaseous components, by introducing a gasification or oxidation agent. Here, in particular by the volume expansion of the full stream which is associated with oxidation and/or by the pressure and/or the velocity of the introduced gasification agent, preferably in addition to gaseous material also liquid and solid material, and, in particular, the full stream, in particular the unseparated full stream, is transported preferably from a material inlet port in the direction of a material outlet port of the oxidation unit, and preferably through the oxidation unit. Preferably, the full stream is transported from a pyrolysis unit via the oxidation unit in the direction of a reduction unit. The transport, respectively the described pneumatic transport, preferably takes place along an axis extending between the material inlet and the material outlet. This axis is preferably defined by the oxidation unit and its inner walls, respectively. The transport is made preferably substantially continuously. Thus the stream is transported along the oxidation route and substantially simultaneously with oxidation, preferably by means of the oxidation or gasification agent. Furthermore, the transport of the material is performed preferably independently of the reaction and preferably through a flow cross-section orifice at the transition from the pyrolysis unit to the oxidation unit, as well as alternatively or additionally by introducing an additional mass flow, preferably by introducing a gasification agent. The gasification agent is preferably introduced at a pressure above the pressure existing in the pyrolysis or oxidation unit and at a rate higher than 0 m/s. Preferably gases, such as air, steam, carbon dioxide and/or oxygen, are used as gasification agent. Preferably, CO₂ which is at least partially contained in engine exhaust gases is used as gasification agent. With regard to the full stream, the introduced transportation agent is preferably oxidizing, reductive and/or inert.

Here, the pyrolysis unit preferably has a flow cross-section through which the volume stream of the full stream flows and which is larger than or equal to the flow cross-section of the oxidation unit. Preferably, the full stream from the pyrolysis unit is introduced into the oxidation unit, relative to the gravitational field, substantially from above.

Preferably in or on the oxidation unit several nozzle units are arranged for introducing a gasification agent. Such units for introducing gasification agents are preferably arranged along the transportation route or the length of the oxidation unit and/or along the cross-section of the transportation route or the oxidation unit. Blending the gasification agent introduced through the nozzle units and the full stream from pyrolysis can be improved by means of fluidic fixtures, preferably however by means of a specific arrangement or design of one or more nozzle units.

Thus, it is advantageous to supply the gasification agent to the oxidation unit by means of one or more injection nozzles or swirl nozzles. In particular, supply by means of a swirl nozzle leads to turbulent flows in the oxidation area which improve blending of the gasification agent with the full stream. Additionally or alternatively, other fluidic fixtures, such as obstacles, modifications of the cross-section of the oxidation unit (shape and/or size of the cross-sectional area) may also improve a blending of the gasification agent with the full stream. The oxidation unit may in particular be designed according to the Venturi principle, preferably as Venturi nozzle or Venturi tube. For example, a tube section with a contracted cross-section may be formed by two cones directed against each other, which are combined or merge at the site of their smallest diameter.

Preferably, in particular where larger particle sizes of the solids in the stream coming from the pyrolysis unit occur, a gasification agent is introduced into the oxidation unit at several positions along the transportation route, i.e. along the at least one axis extending between material inlet and material outlet, along the oxidation unit and/or along its circumference. According to a preferred embodiment, the axis has at least one, preferably 2, 3 or more axis intercepts which are aligned at an angle to each other. It is especially preferred to adjust or control the flow rate of the full stream in the or from the oxidation unit such that it is substantially constant and that the pneumatic transport of the full stream is ensured.

The pneumatic transport preferably occurs by introducing an oxidation agent. In other words, the oxidation agent fulfils two tasks, namely oxidation and transport of the full stream. The advantageous pneumatic transport may, however, also be effected by another gas, i.e. by a gas which does not serve as oxidation agent. Thus, it is further preferred to introduce a gas which is not suitable as oxidation agent such that the full stream is pneumatically transported thereby. Here, preferably only a small amount of an oxidation agent is added, since in addition to oxidation, the oxidation agent is not or only partially or insignificantly used for pneumatic transportation.

According to a preferred embodiment, the device comprises a (first) nozzle unit at the entrance, i.e. in the area of the material inlet, of the oxidation route and/or a (second) nozzle unit at the exit, i.e. in the area of the material outlet, of the oxidation route.

Preferably, a first nozzle unit, preferably arranged at the entrance of the oxidation route or unit, serves to introduce a gasification or oxidation agent for transportation, in particular pneumatic transportation, of the mass flow. Preferably, the gasification or oxidation agent introduced via the first nozzle unit serves to oxidize the corresponding mass flow components, in particular, the full stream. To provide a (second) nozzle unit at the end of the oxidation route or in the lower part of the reduction unit which faces the oxidation unit has turned out to be advantageous, in particular for preventing or reducing a pressure loss along the oxidation route and/or for controlling the output. Preferably, the transportation or pneumatic transportation is substantially ensured in particular by the first nozzle unit. The optional provision of at least a second nozzle unit, for example in the area of the material outlet, serves in particular for controlling the output, in particular when further or different fuels are used or serves to stabilize the floating bed. The material is preferably transported continuously, in particular along the oxidation unit. The device according to the invention in particular requires a positive guide or a defined transport of the material or full stream. Here, the full stream is preferably optimally blended, in particular by means of the described arrangement of the nozzle units.

The second nozzle unit which may comprise a plurality of nozzles is preferably arranged such that the flow direction of the nozzle(s) substantially corresponds to the flow direction of the material stream. Preferably, a plurality of nozzles is arranged symmetrically around the material stream, i.e. around the axis of the full stream transport. According to other preferred embodiments, an acute angle to a right angle, i.e. 0≦α≦90°, may be present between the flow direction of the nozzles and the material stream, i.e. along the axis of transportation. Additionally or alternatively, the nozzles or part of the nozzles may be aligned such that swirling occurs along the material transport or the transport axis. For example, the flow direction of the nozzles can be provided such that a tangential component causes an angular momentum or a radial turbulence vertical to the flow direction of the material stream.

In accordance with the invention, oxidation is performed in at least one stage. According to preferred embodiments, oxidation occurs at least in two or more stages. For this purpose, the device of the invention and/or the process of the invention are to be adapted as known to the skilled person. For example, by the provision of several devices switched in line and/or in parallel or by a device having a plurality of oxidation areas.

Preferably, oxidation automatically occurs when first starting the device, for autoignition being required in particular the presence of a specific temperature. Alternatively or additionally, ignition may be triggered or supported by introducing an ignition spark or the like. Depending on the composition of the full stream and on the oxidation agent and their ratios, an initial spark, i.e. a brief supply of energy at the start of oxidation may be sufficient for a subsequent continuous oxidation. It may, however, be also preferred that continuous oxidation only proceeds when external energy is continuously supplied.

Therefore, the oxidation device preferably comprises a device for introducing the required energy, which in the following is also referred to as heating device, ignition device or burning device. Examples for a heating device are a hot-air nozzle, a gas burner, a radian heater, glow or ignition plugs, igniters, etc. Depending on the raw material used or the composition of the full stream that is supplied to the oxidation device, the heating device, as described above, may be merely used as ignition aid, i.e. temporarily when starting the oxidation device, or for continuously supplying energy for maintaining the oxidation process. In addition, the heating device can also be used for supplying energy, when required, for example when the raw material composition and/or the gas composition changes during actual operation.

A heating device may in particular be designed as burner nozzle, which simultaneously is designed on the one hand as burner and/or on the other hand as nozzle for introducing the oxidation agent. For example, a combustible gas mixture supplied through the burner nozzle, for example containing CH₄+O₂, serves as combustion gas for heating. When the oxidation process, e.g. after an initial spark, takes place without an additional supply of energy, it is possible to further introduce only an oxidation agent, for example containing O₂, through the burner nozzle into the oxidation device. Alternatively, preferably both functions are simultaneously fulfilled by the burner nozzle.

According to a preferred embodiment, for starting the oxidation, the mixture is enriched, for example, by introducing e.g. propane, methane, or synthesis/lean gas, which may be recirculated via a recirculation pipe from the reduction unit or downstream gas purification units, preferably however from the first purification step.

Preferably, a reduction unit is arranged at an outlet port of the oxidation unit such that the material discharged from the oxidation unit, i.e. preferably the full stream, preferably directly ends up in the reduction unit. It is especially preferred that the previously oxidized material or the material discharged from the oxidation unit reduce the products of the oxidation unit in the reduction unit, in particular in a reduction zone. In the reduction unit, preferably redox reactions, i.a. between gas and solid, occur.

The reduction unit preferably has a cross-section tapering in the direction of the outlet port of the oxidation unit. Preferably, the cross-section is such that the material to be reduced and in particular the solid and/or liquid material present in the material stream are substantially kept in suspension and is reduced. The reduction unit, and in particular the cross-section or flow cross-section of the reduction unit, are preferably designed such that preferably a stable bed, further preferably a bed kept in suspension, is formed. Here, the bed or floating bed comprises in particular solid bodies or solid particles contained in the material or full stream. The gas contained in the material stream or full stream or its gaseous part preferably flows along the reduction unit, the solid bed preferably being in suspension and stable. Alternatively or additionally, the reduction unit is designed such that a substantially uniform material stream or material flow rate, preferably only of its gaseous part, is achieved by means of the cross-section of the reduction unit.

The flow cross-section of the reduction unit preferably has a trumpet shape extending at least partially in the direction of the material outlet, in particular an inner surface opening in trumpet shape in the flow direction, in particular for allowing the above features. The advantage of such a trumpet-shaped opening outlet mouth consists in preventing in particular flaking zones at its inner surface that are difficult to control, which might cause, for example, turbulences that might have a negative impact on the stability and/or the suspension of the bed. With such a specifically formed shape or such a flow cross-section it is in particular ensured that the flow of the gaseous medium is fed substantially smoothly and without causing flaking over the inner surface. The reduction unit or its trumpet-shaped section preferably has a rooflike or lid-shaped section having an outlet port.

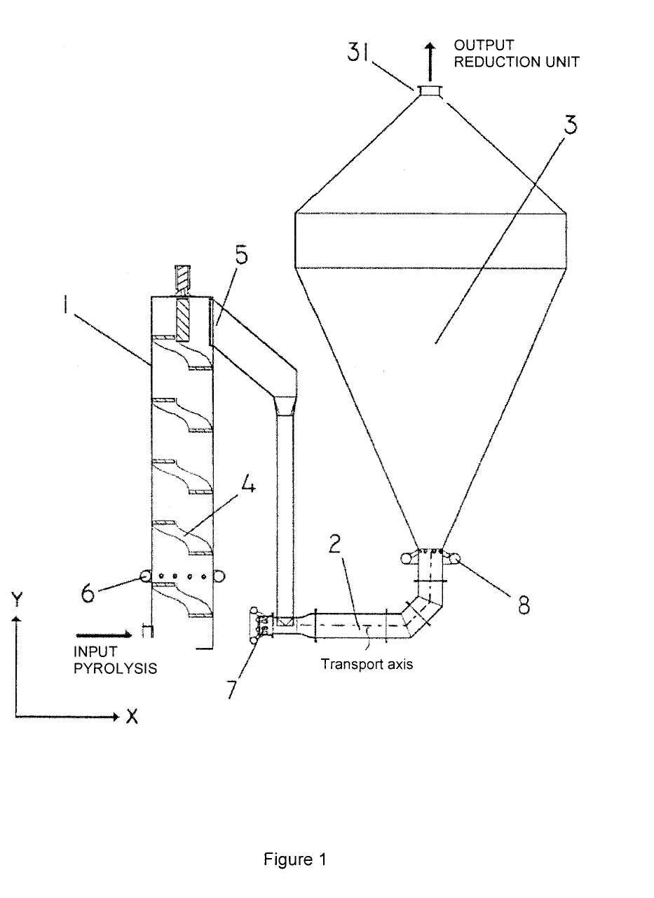

It is noted that the term “trumpet-shaped” comprises different ports, not only circular ones. In particular, the term “trumpet-shaped” refers to rotation-symmetric conical shapes which have a similar form as the bell of a trumpet. It is particularly decisive that the flow cross-section altogether continuously increases in the direction towards the exit of port of the mouth edge, with a “linear” increase in form of a truncated cone-like outlet port not necessarily leading to the desired object. A linear increase may for example be described by means of a linear function: y=ax±b, with this function merely representing the course/direction of a lateral inner wall in a section through the preferably substantially rotation-symmetric body, and the origin of the coordinate system being applied to the inlet end or the lower end (cf. depiction 3 in FIG. 1) of the reduction unit and thus to the trumpet shape, and the y-axis proceeding in the direction of the transportation route, preferably in the upward vertical direction (height of the reduction unit) and the x-axis proceeding horizontally, and thus the amount of the radius or the diameter of the reduction unit at a particular position describing y. Particularly advantageous are widenings, wherein the slope of the inner walls changes continuously and/or discontinuously along the transportation route from the inlet end to the outlet end. For example, the slope of the inner walls at the lower or inlet end differs from the slope of the inner walls at the upper or outlet end of the reduction unit (i.e. the slope is not constant, such as in a linear function). In particular, trumpet-shaped inner surfaces are advantageous that have at the inlet end of the reduction unit a larger slope (e.g. according to the described direction an almost vertical one) and at the outlet end of the reduction unit a lesser slope (e.g. an almost horizontal one).

It may, moreover, be advantageous when the slope of the inner surface between the ends, preferably the lower and the upper ends, preferably changes continuously; for example, the slope of the inner surfaces gets flatter from the bottom up. Mathematically, such graphs may be described for example by an a/x (y=a/x) function or an ay³ (x=ay³) function, with the point of origin having to be applied in these two exemplary functions to the upper end or the rear end of the reduction unit. In FIG. 1, the axes x and y are shown by way of example.

In particular, any function is possible which describes the form of the inner surface within the limits of the linear function and a/x. In other words, the slope of the inner surfaces is to decrease (become flatter) from the bottom (inlet) up (outlet), but preferably not too much. A continuous decrease of the slope of the inner surface (bottom up) has the advantage that the inner surface in its upward direction offers more and more “supporting surface” for the floating bed, which on the one hand receives upward energy from the gas stream and on the other hand downward energy from gravitation. Thus, by shaping the inner surface in combination with the vertical flow rate it is possible to influence or define the position and/or the height or thickness of the floating bed.

It has also been found that different shapes or cross-sections of the reduction unit are particularly advantageous for different raw materials so that the shape of the inner surfaces is preferably adapted to the given raw materials and flow rates. In addition, it is possible to provide a cylinder-shaped attachment at the upper end of the reduction unit, i.e. downstream of the trumpet-shaped widening.

The above features are preferably caused by an adjustment of the cross-section of the reduction unit increasing in flow direction with the expansion e.g. of the volume or gas stream. Preferably, the cross-section of the reduction unit widens in the flow direction approximately in trumpet shape. This substantially prevents turbulences preferably in the reduction zone. The embodiment according to the invention advantageously allows in particular a uniform reduction of the flow rate without turbulences and thus preferably a suspended, uniform and tight bed.

Such a construction likewise causes the bed material to be better supported on the outer wall thus reducing pressure loss.

In the reduction unit, preferably solid or liquid substances up to a specific material particle size are retained by means of a, preferably mechanical, retention system to achieve a specific gas purity at the outlet of the reduction unit. The retention system is optional and preferably provided as gravitational retention system.

For level control in the reduction unit it may be provided with a discharge system, preferably a gravimetric one, or an overflow for removing solids, in particular ash and contaminants, from the reduction unit. The discharge system is preferably circularly arranged, at least in part, around the reduction unit. The discharge system may be located at any position along the reduction zone, preferably, however, at the end of the widening of the preferably trumpet-shaped cross section of the reduction zone. The discharged solids may thus be recirculated into the system or separately removed from the system.

The invention allows a considerable simplification of the gasification unit compared to conventional fix-bed gasifiers and also to partial stream gasifiers. The in particular pneumatic transport of the pyrolysis material to the reduction unit with simultaneous partial oxidation makes possible a reduction of tars resulting from pyrolysis, the provision of the energy required for the subsequent reduction, a complete further transport of all pyrolysis products and the retention of ungassified components by gravitational retention systems. This allows a gasification bed that reduces the full stream without having the disadvantageous pressure loss of a fixed bed and being simultaneously efficient and slag-proof. Mechanical fixtures such as grates and/or the like and/or additional bed material, such as silica sand and/or the like are no longer absolutely required. Likewise manipulation units required for separating the mass flow after pyrolysis are no longer necessary. The high temperature range (oxidation zone) is considerably confined; moreover, a simple construction reduces production and maintenance costs. The process and the device allow in particular a simple technical realization of the main gasification components, a high gas quality already prior to gas purification, a high slag-proof ability and/or high efficiency.

In the following are described preferred embodiments of the present invention with reference to the Figures which show:

FIG. 1 an inventive embodiment of a multi-stage full stream gasifier;

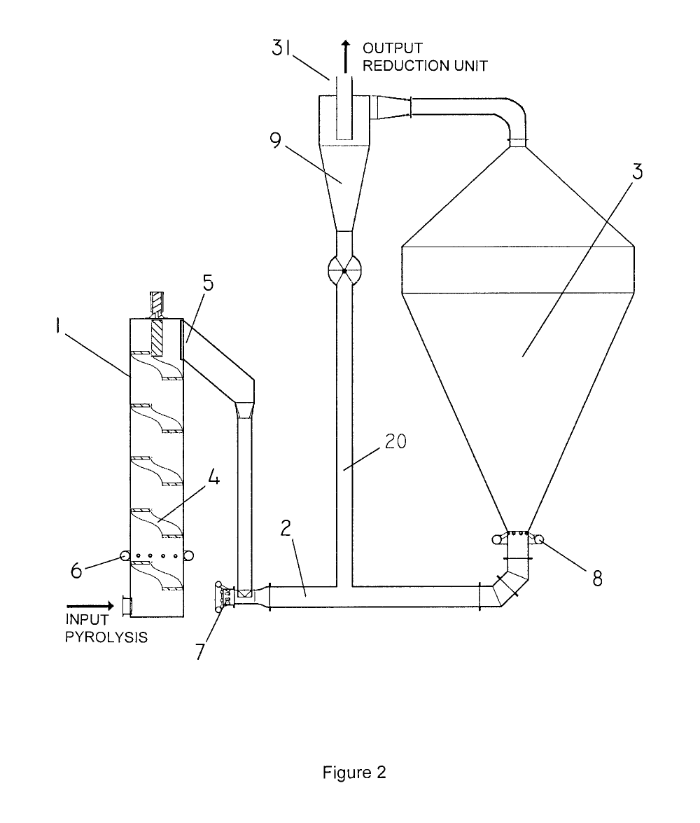

FIG. 2 an inventive embodiment of a multi-stage full stream gasifier with solid return means;

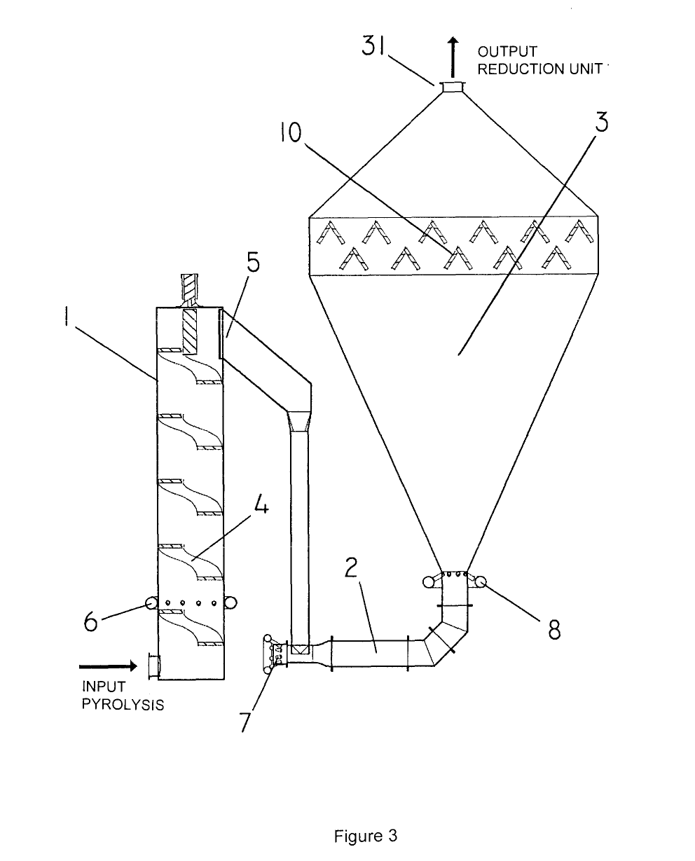

FIG. 3 an inventive embodiment of a multi-stage full stream gasifier with a reduction unit having a solid retention system;

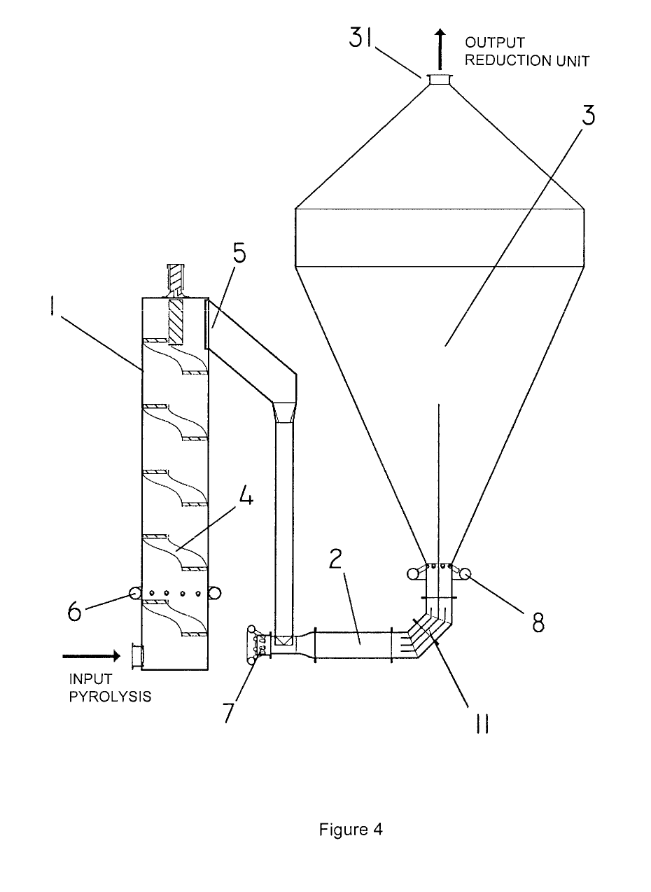

FIG. 4 an inventive embodiment of a multi-stage full stream gasifier with an oxidation unit having stream stabilizers;

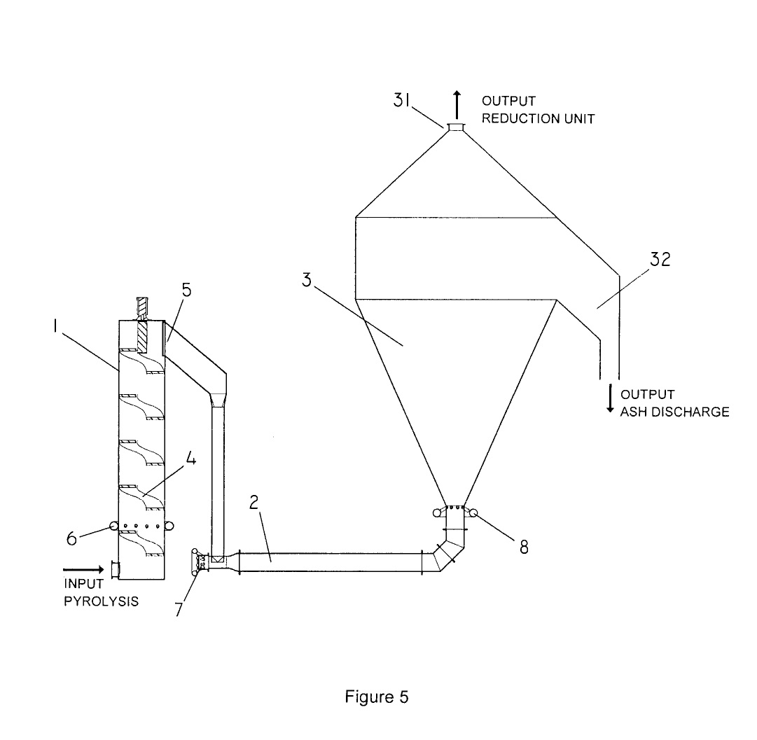

FIG. 5 an inventive embodiment of a multi-stage full stream gasifier with a reduction unit having a solid discharge system;

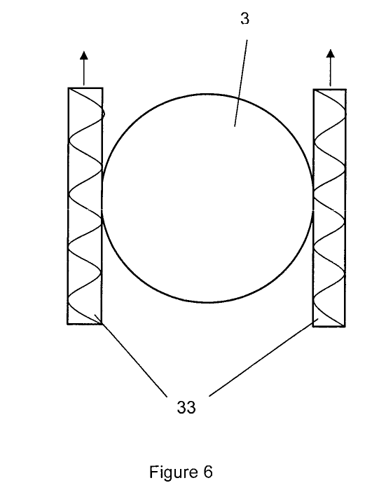

FIG. 6 top view of a discharge unit for removing undesirable materials from the reduction unit; and

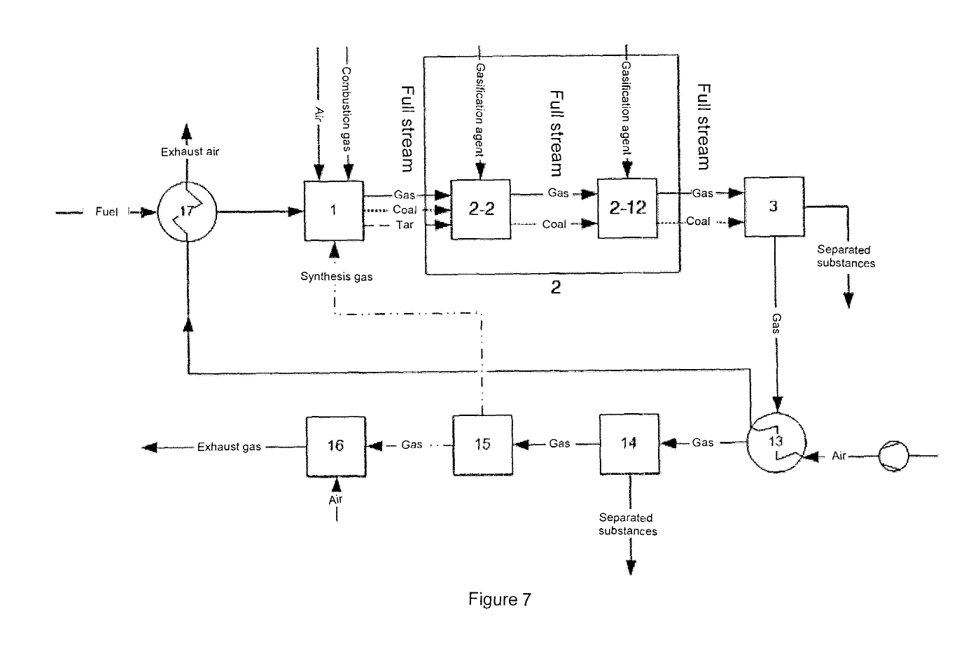

FIG. 7 flow chart of a process according to the invention.

FIG. 1 shows a preferred embodiment of a multi-stage full stream gasifier according to the present invention. Material to be gasified, such as biomass or carbonaceous raw materials is supplied to a pyrolysis unit 1. This is preferably done by means of an axis-free spiral conveying system. The pyrolysis unit is preferably arranged upright or vertically and has a substantially vertical ascending worm screw 4. The pyrolysis material or the material to be gasified is conveyed via a preferably axis-free, substantially vertically arranged screw 4 to a discharger 5. The pyrolysis is preferably performed as allothermal or autothermal carbonization, i.e. with or without external energy supply.

Heat is preferably introduced into pyrolysis unit 1 by means of hot gases. Hot gases are preferably introduced into pyrolysis unit 1 by means of at least one gas nozzle 6. Such gases preferably reduce, oxidize and/or inertly act on the material or charging material.

Instead of injecting hot gases, in autothermal pyrolysis a defined amount of oxidation agent, preferably air or oxygen, is introduced. Thus, a certain portion of the material to be pyrolized undergoes a combustion reaction which supplies the necessary heat for the pyrolysis of the remaining material.

The heat introduced into pyrolysis unit 1 thus may be externally generated or returned from another process step of the full stream gasifier. In pyrolysis unit 1, an autothermal or allothermal pyrolysis of the material to be gasified is ensured. In other words, combustion is prevented preferably by a corresponding atmosphere.

The pyrolysis unit 1 described here represents an advantageous and preferred embodiment which is shown to facilitate the understanding of the invention. It can be replaced by other known pyrolysis units or processes.

The raw material or biomass is preferably introduced into the pyrolysis unit. A material stream generated in pyrolysis unit 1, in particular a full stream with solid, liquid and gaseous components, leaves the pyrolysis unit and is supplied to the oxidation unit 2 preferably unseparatedly.

The material which has passed through the pyrolysis unit reaches an oxidation unit 2 via an outlet 5. In the preferred embodiment shown, the pyrolized material reaches oxidation unit 2 in the full stream gravimetrically together with the pyrolysis gas. Preferably, the material coming from the pyrolysis unit falls via outlet 5 to oxidation unit 2, without further measures. By optional measures, the flow of materials between the pyrolysis unit 1 and the oxidation unit 2 as well as through the oxidation unit 2 can be secured or influenced, e.g. by a shredder arranged substantially downstream of the pyrolysis unit 1.

The full stream discharged from pyrolysis unit 1 and/or introduced into the oxidation unit comprises solid, liquid and gaseous components.

In the oxidation unit 2 of the invention, a gasification agent is introduced into the full stream. The gasification agent is preferably introduced into the full stream by means of at least one nozzle unit 7, 8. A nozzle unit 7, 8 is preferably arranged at the oxidation unit 2 such that by the introduction of the gasification agent the material is substantially transported from a material inlet of oxidation unit 2 through an oxidation zone to a material outlet port. The material is preferably transported by the velocity, the pressure and/or the direction of the introduced gasification agent and/or by an increased volume of the gasification agent that is associated with oxidation. The introduced gasification agent preferably expands at least a part of the full stream thus generating pressure. Preferably the gasification agent alone only partially expands the full stream and additionally the gas fraction of the full stream expands in view of the temperature increase due to preferably exothermic redox reactions of the oxidation unit. The oxidation causes in particular an increase in the temperature and the flow rate of the gas.

The advantage of such a pneumatic transport of the full stream consists in particular in that also full streams with larger particles can be transported. In contrast, in downdraft oxidation it is mostly necessary to preclean the gas stream to be oxidized so that the stream to be oxidized only contains minute particles. Due to the pneumatic transport according to the invention it is therefore possible to supply the full stream produced in the pyrolysis unit substantially directly to the oxidation unit, i.e. without further processing step such as separating, filtering or dividing.

Moreover, the at least partially oxidized full stream can be directly supplied to a reduction unit, i.e. without separation of particles or division. In other words, with a pyrolysis unit, oxidation unit and subsequent reduction unit according to the invention it is possible to directly process a full stream that is produced in the pyrolysis unit and that may also contain larger particles, i.e. without prior treatment, division or separation of specific particles. Accordingly, the system according to the invention operates efficiently and is cost-effective.

Preferably, the transport of the material, the material stream or the full stream occurs by means of the flow rate and optionally by means of the volume of the introduced gasification agent, or assisted thereby. It is further preferred that the transport of the material through the oxidation unit is assisted by a special design of the flow cross sections of the device. Preferably, the flow cross-section in the area upstream of the oxidation unit 2 has a first dimension which is larger or equal to the dimension of the flow cross-section of the oxidation unit. The oxidation unit and/or the feed to the oxidation unit are preferably approximately tubular. Preferably, the feed to the oxidation unit has a diameter of about 10 cm to 60 cm, in particular about 30 cm, and the oxidation unit has a diameter of about 5 cm to 30 cm, in particular about 20 cm. The dimensions and proportions are preferably in particular dependent on the output of the device.

The direction of the oxidation unit or the transport axis thereof is preferably approximately horizontally, and further preferred in a range from about +60° to −60° relative to the horizontal. The material introduced into the oxidation unit preferably has a flow direction which is aligned in an acute angle relative to the flow direction of the material in the oxidation unit and preferably at an angle from about 10° to 100° relative the flow direction or the transport axis of the material in the oxidation unit. The angular alignment of the zones to each other and/or the ratio of the flow cross-sections upstream and in the oxidation unit 2 results preferably in pull which assists the transport of the material along the oxidation unit 2.

The blending of both streams, in particular of the pyrolysis full stream and the gasification agent stream, and in particular together with a reduction of the flow cross-section in the oxidation zone ensures preferably the transport of the material, in particular through or along the oxidation unit.

Preferably, the transport of the material is further assisted by combustion and an increase in temperature.

Oxidation unit 2 is designed such that the material is transported in the direction of the material outlet port by means of pressure and/or the additionally mentioned mechanisms. Preferably, the flow cross-section of oxidation unit 2 increases and/or decreases at least partially in the direction of the material transport, i.e. in the direction of the material outlet. Alternatively, this flow cross-section is preferably constant or in the entrance area of the full stream from pyrolysis provided as Venturi nozzle.

As shown in FIG. 1, at least one nozzle unit 7 having one or more nozzles for introducing a gasification agent is arranged outside of the route of the volume stream. Preferably, a nozzle unit 7 is arranged in the area of a change of direction of the volume stream or in the lower part of the reduction zone. Like in the preferred arrangement depicted in FIG. 1, the volume stream upon entering oxidation unit 2 preferably undergoes a change of direction of about 20° to 160°, preferably of about 20° to 70°, about 45° to 135° and also preferably of about 90° or about 45°. Especially preferred is a change of direction at an acute angle to the transport axis of the oxidation unit 2 in flow direction so that there is no sudden change of direction of the stream. Here a nozzle unit is preferably arranged outside of the volume stream and in alignment with the route of the volume stream in the oxidation unit, preferably rearward to or behind the route and/or outside the route of the volume stream in the oxidation unit. There, preferably also the heating or ignition device is arranged.

The gasification agent is preferably introduced at several positions along the oxidation unit 2. In particular, by this multi-stage oxidation, the full stream gasifier is able to process solid full stream components of different sizes. Preferably, liquid full stream components, such as tars, too are preferably substantially completely oxidized or decomposed or cracked by the high temperatures prevailing in the oxidation unit.

The design of the oxidation unit according to the invention and in particular the introduction of a gasification or oxidation agent into the full stream according to the invention, in particular at several positions along the oxidation unit, causes a high, turbulent current which again leads to a good blending of the full stream and thus to improved oxidation.

It is particularly preferred to adjust or control the rate of the full stream, in particular in multi-stage oxidation, with the effect that it is inter alia possible to control the stream from the oxidation unit 2 which contains synthesis gas or lean gas. Thus, in particular the pneumatic transport is ensured under different operation conditions.

Preferably, a nozzle unit 8 for introducing a gasification agent is arranged upstream of and/or at the material outlet of the oxidation unit 2. Thus, liquid and/or solid substances still contained in the full stream can be oxidized. Preferably, the at least one nozzle unit 8 substantially corresponds to the above described nozzle unit 7. Nozzle unit 8 may be arranged radially around the oxidation zone at an angle of −45° to +45°, preferably, however, 0° , relative to the radius, and axially to the direction of flow at an angle of −45° to +85°, preferably, however, from 0 to +60° , and preferably in particular of 45°, relative to the direction of flow. For example, blending may be improved by a plurality of injections, for example 2 to 12 injections, in particular 6 injections, i.e. by nozzles arranged around the circumference of the oxidation unit or around the transport axis, which introduce gas along an axis not cutting through the transport axis, e.g. along a tangential direction.

The nozzle unit 7, 8 preferably allows alternatively or additionally to adjust and/or control the full stream. In particular, it preferably allows to control the output under different operating conditions and/or to stabilize the bed in the reduction unit 3.

The material outlet of the oxidation unit 2 is preferably connected to a reduction unit 3 so that material discharged from oxidation unit 2 ends up in the reduction unit 3. Reduction unit 3 is preferably arranged upright so that the material flows through reduction unit 3 substantially vertically, and preferably contrary to gravitation. Here the material flow is controlled by oxidation unit 2 and nozzle units 7, 8, respectively, such that in reduction unit 3 a moving reduction zone, in particular a floating bed, is formed without additional bed or propping material. This is preferably assisted or caused by the geometry of the reduction unit and in particular its trumpet-shaped widening in the direction of flow. In the reduction zone, essentially remaining carbon is reduced with low-tar gas discharged from oxidation unit 2.

By the upright arrangement of reduction unit 3 the non-gaseous components in the material stream are retained by gravitation, preferably they remain suspended in the reduction unit, preferably until they have been reduced to gas.

The essentially vertical arrangement of the reduction unit has the further effect that at least two essentially opposed forces act on the material stream or the at least partially oxidized full stream so that preferably a decongestion of the (floating) material bed is achieved. On the one hand, gravitation has the effect that in the reduction unit the particles present in the full stream or the gas stream are subjected to a downward directed force or pulled downward. On the other hand, the gas stream directed upward has the effect that the particles are subjected to an upward force or led upward. Finally, on the basis of these essentially opposite forces a floating material bed is formed which is decongested. In typical fixed-bed gasifiers from the prior art, the gas stream and the gravitation are often aligned so that the material bed solidifies. Moreover, the prior art fixed-bed is supported on a grate, and thus does not float.

The reduction unit preferably comprises at least one outlet for discharging the produced combustion gas (synthesis gas) which in the following is also referred to as outlet or gas outlet. In addition, the reduction unit may have at least one further outlet for discharging residual material which in the following is also referred to as material outlet. At gas outset 31 of reduction unit 3, the material stream mainly consists for example of synthesis gas which after optional steps such as cooling, for example in a heat exchanger, and/or purification, may be conveyed to a gas tank, a combustion engine and/or another utilization. It is particularly preferred to recirculate the energy obtained from cooling in the system. Thus, for example, the material to be gasified or the biomass can be dried without external energy supply.

FIG. 2 shows a preferred embodiment with a solid return means 9. The solid return means 9 is arranged between the outlet of reduction unit 3 and oxidation unit 2. Thus it is possible to return to the oxidation unit 2, for example, any solid and/or liquid components that are contained or possibly left in the material stream and that leave the reduction unit 3 through gas outlet 31. This measure ensures that essentially no solid and/or liquid components remain in the synthesis gas. It is thus possible to convert the returned components at least partially into gas resulting in an improved efficiency. Moreover, this measure leads to an improvement of the purity or quality of the synthesis or lean gas downstream of the solid return unit 9. Preferably, however, the gas leaving the gas outlet 31, e.g. synthesis gas or lean gas, already is of high purity and preferably does not contain any or only small amounts of solids or liquids.

The returned material is preferably introduced into oxidation unit 2 at a position located downstream of the material inlet in the direction of the full stream, where material from pyrolysis unit 1 is introduced into oxidation unit 2. The returned material is preferably introduced in the direction of flow, preferably at an acute angle relative to the transport axis of the full flow in oxidation unit 2. Alternatively, the introduction preferably also takes place in the area between pyrolysis unit 1 and oxidation unit 2, for example, into down-pipe 20 that is shown in FIG. 2 between units 1 and 2.

FIG. 3 shows a full stream gasifier according to the invention comprising a preferred reduction unit 3 having a retention unit 10. Retention unit 10 serves in particular for retaining solid and liquid components of the material stream. Retention unit 10 is preferably designed such that it has a stabilizing effect on the reduction zone or the floating bed in reduction zone 3. Thus, it is possible to control the properties of the reduction zone and preferably also the reduction of the materials transported from oxidation unit 2 into reduction unit 3. Retention unit 10 is preferably adjustable so that the flow resistance of the material flow can be changed or optimized by reduction unit 3.

FIG. 4 shows a full stream gasifier according to the invention with a preferred oxidation unit 2 having a stabilization unit 11. Stabilization unit 11 is designed to prevent in particular turbulences of the full stream during transport through oxidation unit 2. Stabilization unit 11 is preferably arranged, at least in places, along the oxidation unit, e.g. in curves or bends of the oxidation unit. Part of the stabilization unit shown in FIG. 3 preferably extends into reduction unit 3.

FIG. 5 shows a full stream gasifier according to the invention with a discharge unit or overflow 32. The discharge unit is preferably mounted to the reduction unit such that upstream of the gas outlet materials can be removed from the reduction unit via the discharge unit or the overflow. Preferably, the discharge unit, at least in part, is arranged around the reduction unit, preferably circularly. The discharge unit or overflow is provided for removing from the full stream gasifier undesirable materials, such as ash or contaminants, which can be reduced and thus converted into their gas form only conditionally or insufficiently or in a time that is not sufficiently short. These undesirable materials are preferably discharged gravimetrically and/or via a mechanical system 33 into the discharge unit (overflow) starting from a preset or adjustable filling level of the floating bed. The discharge unit ends in a gas-tight discharge means, preferably in a gate lock or rotary air lock. The discharged solid, liquid and/or gaseous components can be returned into the system or preferably discharged or partially returned and discharged.

FIG. 6 shows a top view of a preferred reduction unit having a mechanical system 33 for discharging undesirable materials, such as ash and/or contaminants, in particular according to the preferred embodiment of FIG. 5. In this exemplary embodiment two conveyor screws 33 are laterally arranged from reduction unit 3, which convey the undesirable materials from the reduction unit, preferably away from the floating bed. For example, the conveyor screws can be located at a level that the upper edge of the built-up floating bed will always be removed starting from a specific, preferably adjustable level thereof, and that thus through the discharge unit the position of the upper edge of the floating bed can be defined. Such discharge units are particularly advantageous when raw materials or biomass, such as sludge, are/is used that produce(s) much ash. Thus, a discharge unit preferably plays a secondary role only when the raw material wood is used. In particular, when wood is processed, the ash is preferably discharged together with the gas stream.

FIG. 7 shows a flow chart of a preferred gasifier according to the invention. Preferably a raw material or fuel is freed from possibly contained moisture in a drying step 17. Preferably the excess water content is removed which due to the required vaporization energy might turn out to be energetically problematic in the pyrolysis step. In particular, the pyrolysis is already endothermic so that in case of a too high water content even more energy must be supplied for pyrolysis which leads to efficiency losses. As already discussed above, the energy for pyrolysis is preferably returned from later process steps.

After drying the fuel is conveyed to pyrolysis unit 1. By the introduction of heat, for example hot exhaust gases from a burner or engine, the fuel is converted in the pyrolysis unit in particular into solid, liquid and/or gaseous components, preferably the components gas, coal and tar, which together form the full stream. It is also preferred that the gasification is autothermic, i.e. without external energy supply. Instead of an injection of hot gases, in autothermic pyrolysis, a defined amount of oxidation agent, preferably air or oxygen, is introduced. Thus, a certain amount of the material to be pyrolized undergoes a combustion reaction which supplies the required heat for the pyrolysis of the remaining material.

After pyrolysis, the full stream is conveyed to oxidation unit 2, preferably completely or unseparatedly. By the introduction of an oxidation agent or gasification agent, components of the full stream, in particular the bituminous gas resulting from pyrolysis and the remaining carbon, are at least partially oxidized. Through the introduction of the oxidation agent and/or through the volume expansion of at least part of the full stream which is the result of oxidation, the full stream is conveyed from the material inlet port to the material outlet port of oxidation unit 2. The oxidation agent is preferably introduced into the full stream at at least two different positions 2-2, 2-12 of oxidation unit 2, inter alia as already described. By this the transport, in particular the flow rate of the full stream, the output and/or the bed can be controlled. Preferably, the control is made by sensing the volume stream, e.g. providing corresponding sensors, e.g. in the full stream, preferably at the material outlet of the oxidation unit and/or in the reduction unit, preferably at the outlet of the reduction unit, and by correspondingly controlling the introduction of the oxidation agent on the basis of the information gathered by the sensor(s).

The full stream is conveyed from oxidation unit 2 into reduction unit 3. After oxidation, the full stream preferably essentially does not contain tars, since these preferably already oxidize in the oxidation unit. Reduction unit 3 essentially reduces low-tar gas with carbon.

The hot gas leaving the reduction unit, which has temperatures from about 500° C. to 900° C., is preferably cooled in a heat exchanger 13, with the heat preferably being used in the drying of the fuel in heat exchanger 17.

In a subsequent gas purification 14 contaminants still residing in the gas, such as dust, are removed. After the optional purification, the synthesis gas is conveyed for example to a gas tank 15 or a combustion engine and/or to another utilization unit 16.

1.-39. (canceled)

40. A reduction unit for reducing a full stream comprising solid, liquid and gaseous material discharged from an oxidation unit wherein the flow cross-section of the reduction unit enlarges in a trumpet-shaped manner substantially in the flow direction towards the outlet of the reduction unit so that the solid and/or liquid material present in the full stream is basically held in suspension and a substantially stable floating bed is formed.

41. A reduction unit according to claim 40, wherein the stable floating bed is present in the reduction unit without the use of mechanical fixtures like grates and/or additional bed material like quartz sand.

42. A reduction unit according to claim 40, wherein the flow rate of the material stream is substantially constant over the cross-section of the reduction unit.

43. A reduction unit according to claim 40, wherein the flow cross-section enlarges towards the outlet continuously, however not linearly, and
preferably the slope of the inner wall at the inlet end is different from the slope of the inner wall at the outlet end, wherein preferably the slope of the inner wall at the inlet end has a larger slope than at the outlet end,
wherein further preferably the widening of the flow cross-section changes from the inlet end to the outlet end continuously and/or discontinuously,
whereby an increased support of the bed material is achieved.

44. A reduction unit according to claim 40, wherein the reduction unit is arranged basically upright or vertically so that the material flow through the reduction unit takes place basically vertically and preferably contrary to gravitation.

45. A reduction unit according claim 40, wherein the reduction unit has an overflow for the discharge of solid, liquid or gaseous materials, wherein the overflow is preferably arranged around the reduction unit and has at least a discharge pipe leading downward with the material discharge taking place gravimetrically and/or with the overflow preferably having a mechanical discharge system.

46. A reduction unit according to claim 40, further comprising a, preferably adjustable, retention unit for stabilizing the bed held in suspension.

47. A system for thermochemically converting fuel material, in particular biomass or carbonaceous raw materials, such as wood chips, into combustion gas, comprising:
(i) a pyrolysis unit for thermally decomposing the fuel material, in particular to a full stream comprising solid, liquid and gaseous material;
(ii) an oxidation unit located downstream of the pyrolysis unit for oxidizing the full stream, and
(iii) a reduction unit located downstream of the oxidation unit according to claim 40,
said system being so designed that the full stream from the oxidation unit is supplied to the reduction unit for generating combustion gas.

48. A method for reducing an at least partially oxidized full stream, in particular by using a reduction unit according to claim 40, comprising the step of:
pneumatically transporting the unseparated full stream from an oxidation unit into the reduction unit for an at least partial gasification of solid and/or liquid components,
wherein the flow rate of the full stream in the reduction unit is adapted to the material of the full stream and to the shape of the flow cross-section of the reduction unit such that a stable floating bed is formed in the reduction unit.

49. A method according to claim 48, wherein a reduction zone is designed in the reduction unit in which swirls are basically avoided.

50. A method according to claim 48, wherein the material flow is vertically conducted through the substantially vertically arranged reduction unit so that at least two essentially opposite forces act on the full stream such that the floating bed is formed as a floating material bed, in particular in the form of a stable solid bed held in suspension.

51. A method according to claim 49, wherein gravitation has the effect that in the reduction unit the particles present in the full stream are subjected to a downward force, and the upward gas stream has the effect that said particles are subjected to an upward force, whereby the floating material bed is formed on the basis of these essentially opposite forces and the support of the bed material due to the reactor form.

52. A method according to claim 47, wherein the upper border of the built-up floating bed is always removed starting from a particular, preferably adjustable, height thereof, whereby the position of the upper rim of the floating bed can be defined.
